(19) United States
(12) Patent Application Publication
(10) Pub. No.: US 2025/0389139 A1
(43) Pub. Date: Dec. 25, 2025

(54) Locking Device Assembly for Use in Conjunction with a Commercially Available Cylinder Type Lock

(71) Applicant: Joel Sikkila, New Ipswich, NE (US)

(72) Inventor: Joel Sikkila, New Ipswich, NE (US)

(21) Appl. No.: 18/752,076

(22) Filed: Jun. 24, 2024

(51) Int. Cl. E05B 67/06; E05B 67/00

(52) U.S. Cl. CPC E05B 67/063; E05B 67/003

(57) ABSTRACT

A novel, portable locking device assembly is disclosed. The assembly is adapted to utilize a commercially available cylinder lock, which is commonly utilized in an application where the lock is not permanently affixed to the item intended to be secured. The present invention assembly consists of two or more independent components, which when joined together, are then secured together by the insertion, into a suitably sized cavity in one of the components, of the separate cylinder lock previously mentioned. Thereby, the assembly allows for a standard, commercially available cylinder lock to be inserted, forming a secure, locking device assembly which may be utilized to secure an otherwise moveable object to a fixed, immoveable object, or to secure multiple moveable items together, and/or prevent unauthorized removal of the item(s).

### CROSS REFERENCE TO RELATED APPLICATIONS

This application claims the combined benefits of Provisional applications, Ser. Nos. 63455026, 63455033, and 63455036 filed Mar. 28, 2023. The entire contents of which are hereby expressly incorporated by reference herein.

### FIELD OF THE INVENTION

The present invention generally relates to accessories for commercially available cylinder type locks.

### BACKGROUND OF THE INVENTION, PRIOR ART

Commercially available, there exists numerous, removable cylinder locking mechanisms, which are utilized to secure roll-up, overhead doors, of the type often found in use on a self-storage unit entrance. Such cylinder-type locks are utilized almost exclusively in the self-storage industry. Becoming more and more prevalent in usage, it has become apparent that an individual or entity which purchases such a lock, to utilize in such an application, often lacks additional usage for the lock once it is no longer required for its primary intended use. Often, the lock is discarded and not recycled for additional, future uses. Therefore, it has become necessary to provide for novel, additional usages for the lock, once it is no longer utilized or in service in such an application.

Some effort has been made to address this issue. U.S. Pat. No. 11,098,501 issued to Ramsey on Aug. 24,2021 teaches a hasp style lock, which is adapted to incorporate the usage of a cylinder type lock. This patent requires the use of an existing hasp type fastener and relies on an existing hinge type mechanism to maintain the connection between two primary components of the item. This patent allows for the hasp to remain functional without the need for a cylinder type lock, as the cylinder type lock only serves to secure the hasp from movement. The present invention requires all primary components as well as the cylinder type lock to work in unison for the assembly to perform properly. The present invention is summarily different from Ramsey in this regard, and in that it is both portable and encourages the complete separation of the primary components. The present invention is unique in that all primary components are separate and independent of each other, but when the primary components are combined with the cylinder lock in the assembled state, each of the primary components and the cylinder lock serve to secure the rest of the assembly in its entirety, and neither the primary components nor the cylinder lock are effective without the others in the assembly.

U.S. Pat. No. 10,017,959 B2 issued to Janus International Group LLC on Jul. 10, 2018 teaches a lock arrangement where a cylinder type lock can be correctly positioned and orientated in a door latch. This patent requires a fixed mounting location of the door latch, and both primary components to be mechanically or slidably connected together. This patent allows for the door latch to remain functional without the need for a cylinder type lock. The present invention requires all primary components as well as the cylinder type lock to work in unison for the assembly to perform properly. This is the intent of the present invention, as it is reliant on the existence of the cylinder type lock for proper performance.

Numerous other prior art exists which teach a removeable lock cylinder, such as may be found in a door knob, or latch used to secure an otherwise openable or pivotable object. These prior art examples notably require the use of proprietary lock cylinders. The present invention allows for reciprocity between manufacturers of the specific cylinder type locks, as a relative industry standard exists in this regard.

Therefore, it is the object of this invention to provide an additional usage(s) for such a cylinder type lock.

It is the object of the present invention to provide a unique, commercially available assembly, which may be purchased together with a cylinder type lock or separately from as needed, for the means of securing items such as bicycles, equipment, or other items of value, to prevent unauthorized removal.

It is another object of the present invention to provide several models and styles, whereby each model is applicable to a certain type and/or manufacturer brand of cylinder lock, as there may exist variations in size and shape between manufacturers of the same.

It is another object of the present invention to provide the ability for the usage of the assembly where in occurrences where multiple of the bars, rods or plate components exist within the assembly, that one of the bars, rods or plates is permanently affixed to the rigid body, requiring only one of the connected rods or plates to be free, and thereby helping to avoid misplacement of just one of the primary components.

It is another object of the present invention to provide the ability for the usage of the assembly where each of the rods or plates are independent of each other, and each affixed to its own respective wire rope, chain, etc., whereby the free end of each wire rope, chain, etc. may be then affixed to another object. In such a case, the assembly may be then utilized in the fashion of a security barrier to prevent entry into a restricted area, whereby the lock, placed in a serviceable location in the combined overall length of the wire rope, chain, etc., may be released to allow entry or passage as necessary.

It is another object of the present invention to utilize the same mechanical locking mechanism as previously described, to provide a vehicle receiver tow hitch pin locking device.

It is another object of the present invention to provide several models and styles, whereby each model is applicable to a certain type and/or manufacturer brand of cylinder lock, as there may exist variations in size and shape between manufacturers of the same.

It is another object of the present invention to provide several models and styles, whereby each model is applicable to a certain type and/or manufacturer brand of vehicle tow hitch receiver, as there may exist variations in size and shape between manufacturers of the same.

It is another object of the present invention to utilize the same mechanical locking mechanism as previously described to provide a portable lock body and rigid looped securing assembly. This type of lock assembly is often referred to as a “padlock” type.

It is another object of the present invention to provide several models and styles, whereby each model is applicable to a certain type and/or manufacturer brand of cylinder lock, as there may exist variations in size and shape between manufacturers of the same.

It is another object of the present invention to provide several models and styles, whereby each model is applicable to a certain type of usage and needs, as there currently exists a wide range of such “padlock” type applications. In the claims listed below the specific embodiments as described do not imply that all embodiments or features must be included in all use cases.

### BRIEF DESCRIPTION OF THE DRAWINGS

FIG. 1 is an overview drawing of the complete invention, in the form of a traditional padlock, shown in exploded view format.

FIG. 2 is an overview drawing of the complete invention, in the form of a vehicle tow hitch lock, shown in exploded view format.

FIG. 3 is an overview drawing of the complete invention, in the form of a traditional padlock, shown in exploded view format in the typical usage case.

FIG. 4 is an overview drawing of the complete invention, in the form of a traditional cable lock, shown in exploded view format.

### DETAILED DESCRIPTION OF THE INDIVIDUAL INVENTION PARTS AND THEIR MECHANICS OF USAGE

PART NO. 1 Primary component, lock body
PART NO. 2 Cavity for removeable cylinder lock
PART NO. 3 Cavity for primary component, rigid bar or rod shackle ends
PART NO. 4 Primary component, rigid bar or rod shackle
PART NO. 5 Retaining notch for cylinder lock
PART NO. 6 Commercially available cylinder lock
PART NO. 7 Vehicle tow hitch receiver
PART NO. 8 Vehicle tow hitch
PART NO. 9 Cable, wire rope, chain, or other durable, flexible means of securing
PART NO. 10 Alignment pin
PART NO. 11 Alignment groove or indentation:

### DETAILED DESCRIPTON OF OPERATION AND USAGE

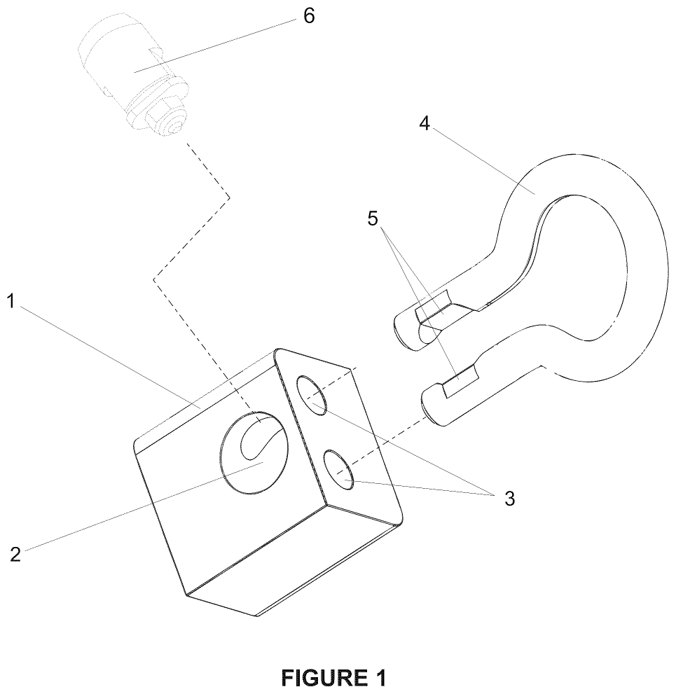

In FIG. 1, the lock assembly is shown in exploded view format. In typical usage, with the assembly in the open, disassembled position, the open, free end of the rod or bar shackle (Part No. 4) is placed around or through the item intended to secure, and if otherwise non-stationary, then also affixed to a secure, stationary object by means of a wire rope, cable, chain, etc. The open shackle end is then inserted into the lock body (Part No. 1). In assembled format, both ends of the rod or bar shackle (Part No. 4) are inserted inside the respective cavities (Part No. 3) on the primary lock body (Part No. 1). With both ends of the now inserted into the primary lock body, the removeable cylinder lock (Part No. 6), is then inserted into the cavity (Part No. 2), to contact and engage with the respective retaining notches (Part No. 5) on the shackle ends to complete and secure the assembly. To remove the lock assembly, the steps are repeated in reverse order. As there exists a number and variety of commercially available cylinder locks, consideration should be made for a variety of primary lock bodies to accommodate such locks as are available. Likewise, consideration should also be made for a variety of overall shackle sizes and lengths, whereby allowances can be made for a variety of use cases for the assembly.

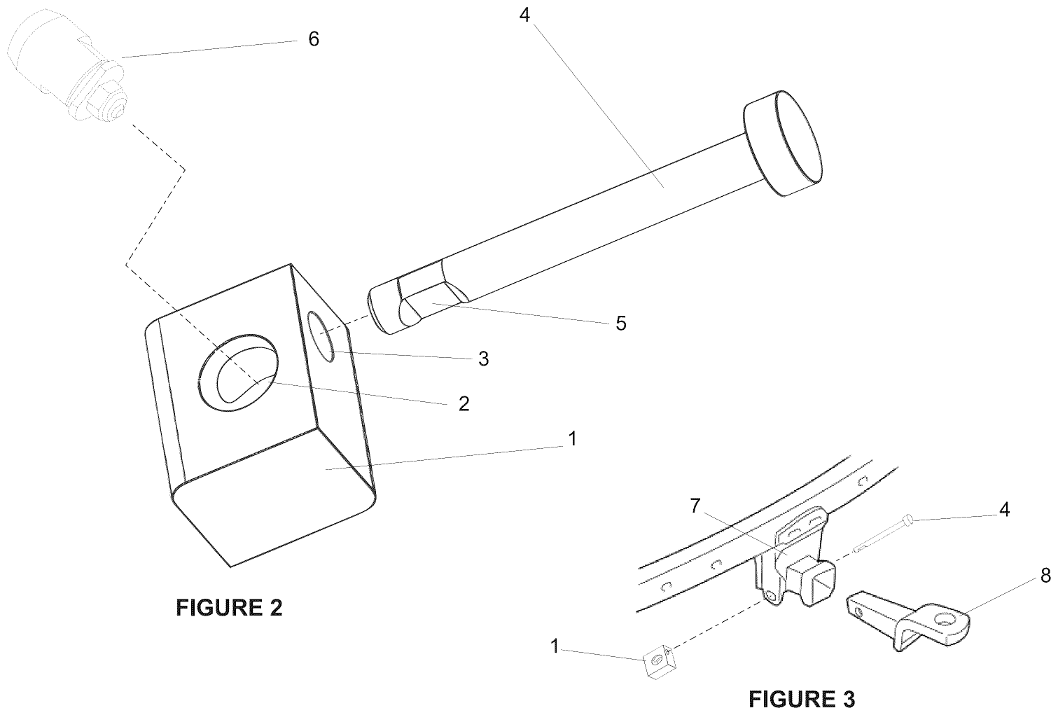

In FIG. 2, the lock assembly is shown in exploded view format. In typical usage, the bar, rod or plate (Part No. 4) consists of the appropriate notch receptacle (Part No. 5) on one end, is sufficient in overall length to allow for complete passage through the object intended to be secured, and into the cavity (Part No. 3) rigid lock body (Part No. 1), and having a enlarged feature on the remaining end to prevent complete passage through the object intended to be secured. Upon installation of the removeable cylinder type lock (Part No. 6) into the cavity on the lock body (Part No. 2), the entire assembly becomes one rigid body, thus securely immobilizing the object intended to be secured.

In FIG. 3, the lock assembly is shown in exploded view format, showing the assembly as described in FIG. 2 previously, in an example usage when utilized to secure a tow hitch to a vehicle tow receiver. In typical usage, the tow hitch (Part No. 8) is installed into the tow hitch receiver (Part No. 7), then secured into the tow hitch by means of the component (Part No. 4). The exposed end of the component (Part No. 4) with the notched receptacle (Part No. 5) is inserted into the rigid lock body component (Part No. 1), and then the assembly is secured together with the cylinder lock (Part No. 6) as previously described.

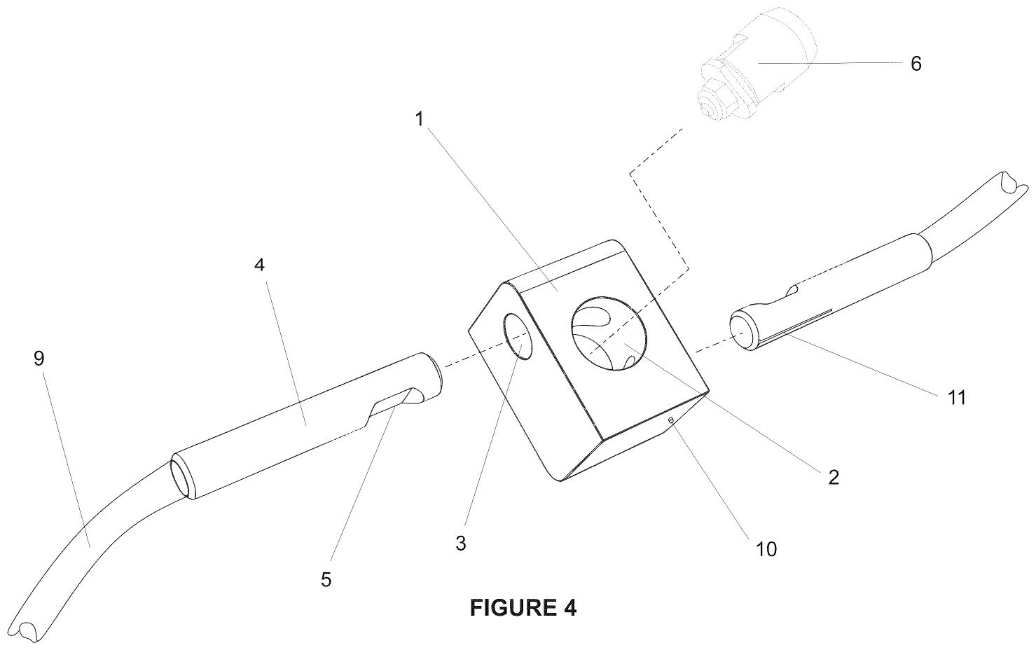

In FIG. 4, the lock assembly is shown in exploded view format. In typical usage, the cable, wire rope, etc. (Part No. 5) is wrapped around or through the item intended to secure, and if otherwise non-stationary, then also affixed to a secure, stationary object. The securing bars, rods or plates (Part No. 4) are then inserted into the appropriate cavities (Part No. 3) in the primary lock body (Part No. 1) prior to the insertion of the removeable cylinder lock (Part No. 7). Each securing bar, rod or plate (Part No. 4) may also include an alignment groove (Part No. 11), that when the bar, rod or plate (Part No. 4) is inserted into the cavity (Part No. 3), and mated with an alignment pin, notch, etc. (Part No. 10) that protrudes into the cavity opening (Part No. 3), it then serves to properly align the securing bar, rod or plate (Part No. 4) in the orientation required for proper installation of the cylinder lock (Part No. 6) into the cavity (Part No. 2) With both ends of the cable, wire rope, etc. (Part No. 5) now inserted into the primary lock body, the removeable cylinder lock (Part No. 6), is then inserted into the remaining cavity (Part No. 2), to contact and engage with the retaining notches (Part No. 5) on the rods or plates (Part No. 4) to complete and secure the assembly. To remove the lock assembly, the steps are repeated in reverse order. As there exists a number and variety of commercially available cylinder locks, consideration should be made for a variety of primary lock bodies to accommodate such locks as are available. Likewise, consideration should also be made for a variety of overall lengths of cable, wire rope, etc., whereby allowances can be made for a variety of use cases for the assembly.

The invention claimed is:

1. A method for assembly of a portable locking mechanism adapted to utilize a commercially available cylinder lock, which is commonly utilized in an application where the lock is not permanently affixed to the item which is to be secured, such as a roll-up overhead door, and the assembly consists of two or more independent components, which when joined together, are then secured together by the insertion, into a suitably sized cavity in one of the components, of the separate cylinder lock previously mentioned, and the whole assembly consisting of: The primary component is a rigid body, of cubical, cylindrical, or otherwise suitable shape for the application, featuring multiple cavities within the exterior face, and on perpendicular sides of the component; The primary cavity, of size and shape to accommodate the commercially available cylinder lock, is on one face of the primary component; One or more secondary cavities, of size and shape to receive the bars, plates or rods as the case may be, are located on faces perpendicular to the primary cavity; Another primary component of the assembly consists of one or more rigid bars, plates or rods of suitably hardened material; A notch or mating receptacle for the separate, commercially available cylinder lock is placed uniformly in each bar, rod or plate; The secondary cavities, as described on the primary component, are placed in such where the bars, plates or rods, when inserted into the secondary cavities, are positioned inside the rigid body, causing the notch or mating receptacle to be visible inside the primary cavity on the perpendicular face of the component; The bars, rods or plates then serve as retention devices, thereby allowing a standard, commercially available cylinder lock to be inserted, mate with the receptacle notch on the bars, rods or plates, forming a secure, locking device assembly which may be utilized to secure an otherwise moveable object to a fixed, immoveable object, or to secure multiple moveable items together, and/or prevent unauthorized removal of the item(s).

2. The method of claim 1 wherein the assembly features the primary rigid body component and two of the second bar, rod or plate component, where the bar, rod or plate components are connected via a flexible chain, rope, cable, etc., of suitable length and size, to comprise a typical “cable lock” assembly.

3. The method of claim 1, wherein the assembly features the primary rigid body component and the second bar, rod or plate component, wherein the second bar, rod or plate component is rigid in nature, with an identical receptacle notch on each end, and formed in such a way to imitate a “padlock shackle”, that each end and its associated receptable notch are both facing and opposing each other. In such a fashion, the assembly may be utilized as a standard “padlock” type locking mechanism.

4. The method of claim 1, where the assembly features the primary rigid body component, and a single bar, rod or plate component, where the bar, rod or plate component is of appropriate length to allow it to be inserted first through a hole or notch in a third, independent component, such as a gate latch, a vehicle tow hitch receiver, or any other usage of similar adaptation which may become apparent, and then into the rigid body component, to be then secured into place by insertion of the separately available cylinder lock.

5. The method of claim 1, where the rigid body component features an alignment pin, notch, etc., and the bar, rod or plate component features an alignment groove or indentation, of the same size and shape of the alignment pin, notch, etc., of the rigid body component. In such usage, the alignment pin would serve to perfectly align the two primary components when joined together, to allow for the receptacle notch of the bar, rod or plate to be perfectly aligned within the cavity of the rigid body component, and to allow for precise placement of the separately available cylinder lock. The order of the pin, notch, etc., and the alignment groove or indentation could be universal, so that either one of the components features the alignment pin, notch, etc., while the other has the mating groove or indentation.

6. It will be readily perceived that each of the claims described above, or two or more claims together, may also find useful application in a myriad of other uses and situations differing from those described above.
